(19) United States
(12) Patent Application Publication
(10) Pub. No.: US 2010/0094861 A1
(43) Pub. Date: Apr. 15, 2010

(54) SYSTEM AND METHOD FOR APPLICATION SESSION TRACKING

(76) Inventors: Henrique Andrade, Croton-on Hudson, NY (US); Steven E. Froehlich, Danbury, CT (US)

Correspondence Address: TUTUNJIAN & BITETTO, P.C., 20 CROSSWAYS PARK NORTH, SUITE 210, WOODBURY, NY, 11797, US

(21) Appl. No.: 12/243,143

(22) Filed: Oct. 1, 2008

(51) Int. Cl. G06F 7/00

(52) U.S. Cl. 707/713

(57) ABSTRACT

A system and method for application session tracking includes activating an application component for execution using an application session tracking facility (ASTF) and intercepting resource requests by the ASTF acting on behalf of this application. Resources are managed by allocating or releasing resources in accordance with resource usage profiles determined by system or application administrators of an application. The ASTF approach allows for controlling the usage of (potentially) distributed resources such as temporary space, database assets such as materialized views, directory services, shared memory segments among others during runtime and their return to their respective free pools and any necessary subsequent cleanup tasks upon a session termination.

### GOVERNMENT RIGHTS

This invention was made with Government support under Contract No.: H98230-07-C-0383 awarded by the U.S. Department of Defense (DOD). The Government has certain rights in this invention.

### BACKGROUND

1. Technical Field

The present invention relates to application management and more particularly to a system and method to track system resources used by an application, to limit the resources used by the application and to clean up any system resources that the application acquired during a session.

2. Description of the Related Art

In large-scale component-based software engineering environments where different components of an application may be developed by different software engineers and technical teams, potentially including open source and off-the-shelf packages, the resulting production computing environment may result in a combination with a broad spectrum of software quality, from the very best designed, developed, and tested, to components with much lower quality. Therefore, for the benefit of the entire application and the computing environment hosting the application, a method to track, limit, and clean-up an application component's usage of system resources can be useful in at least two ways. First, to prevent excessive use or misuse of resources at runtime by limiting and controlling what an application can do; and, second, to restore the pre-run state of the computing environment upon the termination of an application session such that the resource allocations are returned to the operating system (e.g., shared memory segments), databases (e.g., materialized views created by an application's processing), webservices (e.g., temporary webpages), and whatever other resources the application used in the course of its session. For the purposes of this work, a session is a running instance of the application.

The application session tracking problem is even more acute in distributed environments, where application components are deployed on a collection of computational resources. These application components consume resources and alter the computing environment in a similar fashion to a local application, but may also remotely consume resources and impact remote nodes. An application session may span multiple computational nodes including, but not limited to, multi-tier webservice-based applications as well as scientific computation applications supported by MPI (Message Passing Interface) or PVM (Parallel Virtual Machine) as well as applications implemented on top of general purpose middleware such as IBM's Websphere and RedHat's JBoss.

The application session tracking problem also exists in the development environment where immature application components fail in undetermined ways. These failures orphan system resources requiring the developer to track down those orphaned resources either by hand or by writing another application specifically designed to locate system resources allocated by the application component under development and release those system resources.

The problem of tracking and monitoring resource utilization is well understood in the prior art. Operating systems and programming runtime environment typically perform these tasks. For example, as processes change, operating systems act on returning resources such as memory, file descriptors, thread table entries, and other resources, making them available to other applications. Similarly, programming runtime environments also perform a limited amount of resource tracking and management. For example, Java's JVM tracks memory allocation and usage and employs a garbage collection algorithm to identify and return memory back to the unused pool.

### SUMMARY

One distinction between the prior art and the present principles relies on a depiction of a configurable, distributed, application-defined infrastructure for application session tracking. In the present principles, rather than relying on an operating system (OS) or language-specific artifacts as the entities to be monitored, the boundaries of an application and its (distributed) components are explicitly described as are the resources that will be monitored and tracked as a general purpose service.

Since Virtual Machine (VM) support is widely available commercially from vendors such as VMware or Parallels' Parallels Desktop, such support may be configured to be used as the infrastructure for application level resource tracking and limitation. However, VMs currently only deal with resources at a node or user level, not at the application level therefore they do not allow one to describe application level boundaries or the knobs to manage resources for a specific application. By the same token, VM-based approaches do not extend to monitoring and controlling resources acquired applications running on remote virtual machines or on, regular, remote nodes.

Operating system resource management has also been made available through kernel modules. For example, IBM's CKRM (Class-based Kernel Resource Management) is a framework that allows the allocation and usage control of resources such as CPU, memory, I/O, and network bandwidth based on application classes where specific resource shares can be configured. While, in another possible embodiment application session tracking can rely on kernel-based help as a way for operating system-level resource tracking.

Therefore, for the benefit of an entire application, a method to track, limit and clean-up an application component's use of system resources is helpful to prevent additional problems to the other components and to recover from an application component's harmful (intentionally or not) resource allocations during a session and return resources upon an application session's termination.

A system and method for application session tracking includes activating an application component for execution using an application session tracking facility (ASTF) and intercepting resource requests by the ASTF from the application component. Resources are managed by allocating or releasing resources in accordance with resource usage of the application component.

A system for session tracking includes a computer having an operating system and at least one application component stored and executed on computer media. An application session tracking facility (ASTF) is accessible by the computer. An intercepting mechanism is generated by the ASTF to track, limit and release system resources associated with the application component.

These and other features and advantages will become apparent to one skilled in the art from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a passive approach for session tracking which includes an interpose layer generated by a library interposer in accordance with one embodiment;

FIG. 2 is a block/flow diagram showing a passive approach for session tracking which includes a kernel module which substitutes for an operating kernel in accordance with an environmental variable in accordance with one embodiment;

FIG. 3 is a block/flow diagram showing an active approach for session tracking which includes an interpose library in accordance with one embodiment;

FIG. 4 is a block/flow diagram showing a system/method for session tracking in accordance with the present principles; and

FIG. 5 is a block/flow diagram showing a mechanism for system or application administrators to declare on a per application basis which resources are to be monitored and controlled as well as the specific resource utilization limits.

### DETAILED DESCRIPTION OF PREFERRED EMBODIMENTS

In accordance with the present principles, a system and method are provided that track system resources used by an application, limit those resources used by the application and clean-up any system resources that the application acquired during a session. These functions can be helpful in preventing excessive or uncontrolled resource allocations at runtime and recovering resources from an application component at the end of its session, by returning those resources to their respective free pools and performing any necessary cleanup tasks such as deleting materialized views, deallocating shared memory segments, cleaning up temporary scratch space on node clusters, etc.

In the present disclosure, there are at least two possible approaches to providing Application Session Tracking: passive and active. The passive approach employs the Application Session Tracking Facility (ASTF) to intercept all system and service calls to allocate, modify and release any tracked system resource from the application components. Note that different applications might elect to track different resources as described in an embodiment of this invention. Once intercepted, the ASTF can track the resource for possible clean-up later or immediately deny the request by the application component. The request could be denied for any number of reasons such as, e.g., the quota for the requested resource has been exceeded by the application component or because a component should not be using the requested resource.

Unlike the passive approach, the active approach needs the application component itself to be aware of the ASTF, and actively make requests for system resources through the ASTF application programming interface (API) for performing resource allocation on behalf of the application. Therefore, the ASTF is able to track these resources and either forward the request to the operating system or external services/servers (e.g., database, remote file system, etc) or deny the request.

In a preferred embodiment library interposing techniques are used to describe session tracking activities, but the same ideas can be implemented in other ways, such as in a kernel, or extensions to existing virtual machine middleware, or combinations of any of these technologies.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

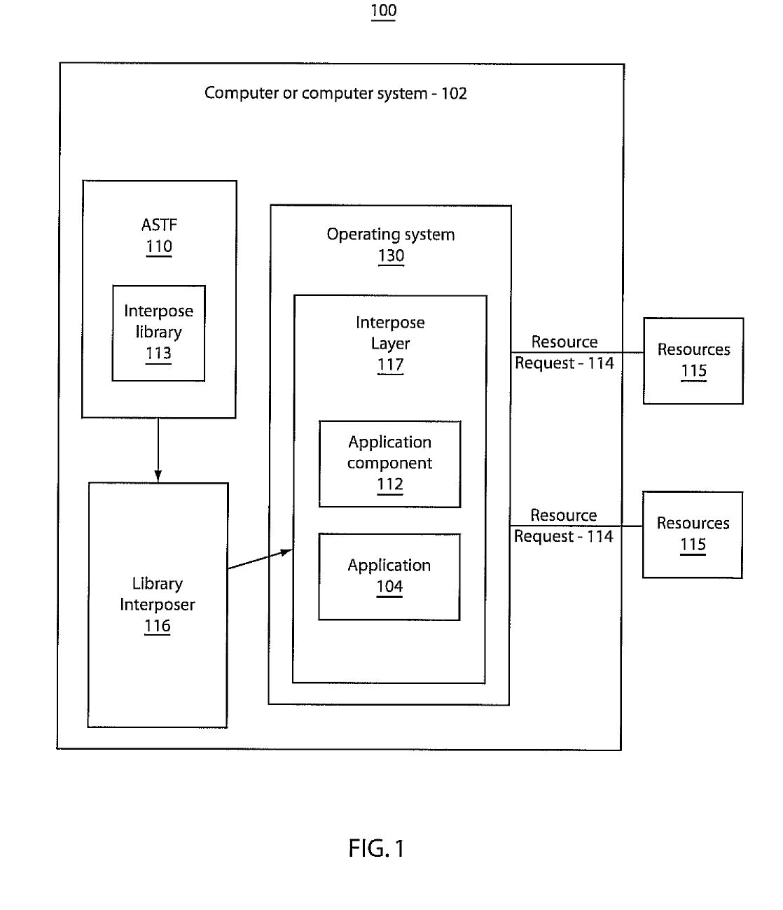

Referring now to the drawings in which like numerals represent the same or similar elements and initially to FIG. 1, a system/method 100 for tracking system resources used by an application, limiting the resources used by the application and cleaning up any system resources that the application acquired during a session is illustratively depicted. System/method 100 includes a computer system 102. Computer system 102 may include a single computer or a distributed computer network. Each computer or network of computers includes an operating system 130 and one or more applications 104 or application components 112 configured to be executed by the computer(s) 102. Applications 104 may include any software title or function that employs system resources 115. An application 104 includes one or more application components 112. System resources 115 may include hardware, such as memory devices, processors, etc., software, such as other applications, program code, etc., data, such as stored information, etc., or energy or facility resources, such as power, computational support, etc.

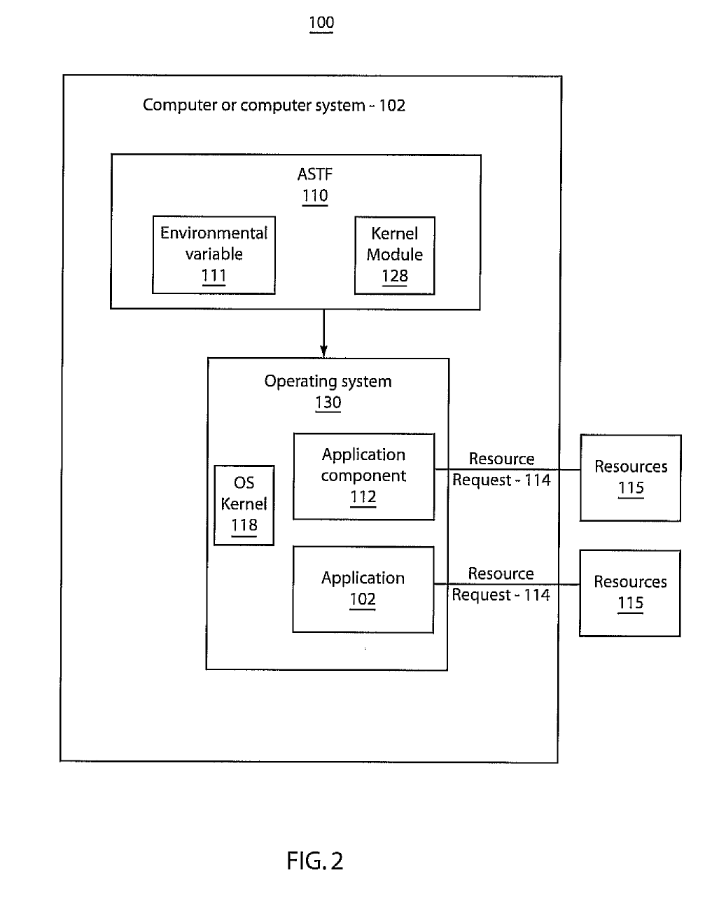

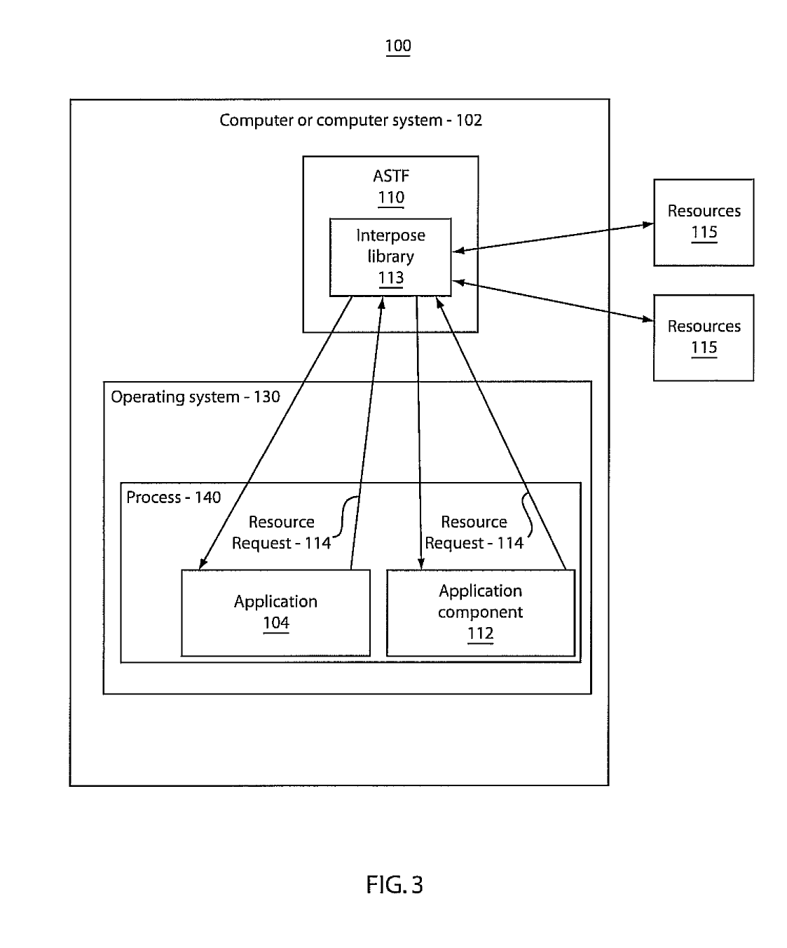

The present embodiments are helpful in controlling and recovering from an application component's resource allocation actions during a session as well as upon the application session termination. In particularly useful embodiments, there are two possible approaches to providing application session tracking, a passive approach (FIGS. 1 and 2) and an active approach (FIG. 3).

In the passive application approach, an Application Session Tracking Facility (ASTF) 110 starts an application 104 or application component 112. The passive approach can be accomplished without any changes to code of the application component 112 by intercepting system resource requests 114 from the application component 112 in at least two different ways.

One way is by inserting a library interposer 116 which is first in the search order to resolve the system calls to allocate or release resources. Library interposition techniques are well described in the prior art, and modern operating systems such as Unix and Windows implement the necessary software hooks required by the implementation of the ideas described herein. Another way is by adding a kernel module 118 (FIG. 2) that intercepts all resource allocating or releasing system calls. With the library interposer 116, the ASTF 110 inserts an interpose library 113 in the search order (for example, in Unix this is accomplished by exporting the environment variable LD_PRELOAD) before starting the application component 112 which causes the passive ASTF library or interpose library 113 to resolve all application component dynamic links for system resources 115.

Therefore, an interpose layer 117 can get control each time the application requests a system resource and then the layer 117 is able to track the resources and possibly limit the amount of the resources 115 consumed by the application 104 or component 112 and finally return the resources to their free pools when the application 104 or application component 112 ends. Note that for well-behaved components that terminate and cleanup graciously (returning the allocated resources and cleaning up on their own) the ASTF would not have to perform any tasks. However, as any person skilled in the art can verify, in many cases, gracious termination does not always occur, and cleanup tasks and resource deallocation are not always implemented correctly.

For statically linked executables, the ASTF 110 would scan and modify the application executable prior to starting the executable. The modifications to the executable would permit the ASTF 110 to track, limit and free the system resources 115 used by the application 112. Since either a dynamically or statically linked application executable would be unable to return control to the ASTF 110 if it terminates abnormally, the ASTF 110 monitors the started application 104 for this situation and releases the system resources if the application abnormally terminates.

Referring to FIG. 2, the other application passive approach employs the modification of an operating system (OS) kernel 118 to permit the ASTF 110 to track, limit and eventually release the system resources 115. One possible implementation has the ASTF 110 setting an environment variable 111 to notify the OS 130 that a starting application 104 should be tracked by an ASTF kernel module 128. Before starting any executable, the kernel 118 checks for this environment variable 111 and if present, passes control to the ASTF kernel module 128 to start and track the application 104 or component 112.

Referring to FIG. 3, an active application approach permits the application 104 or application component 112 itself to request system resources 115 from an ASTF library 113. Then, the library 113 requests the resources 115 from the system 100 and returns the resources to the application 104. A first call to the ASTF library 113 spawns a new process 140 to monitor the application 104 for abnormal failures and releases all tracked system resources should any failure occur.

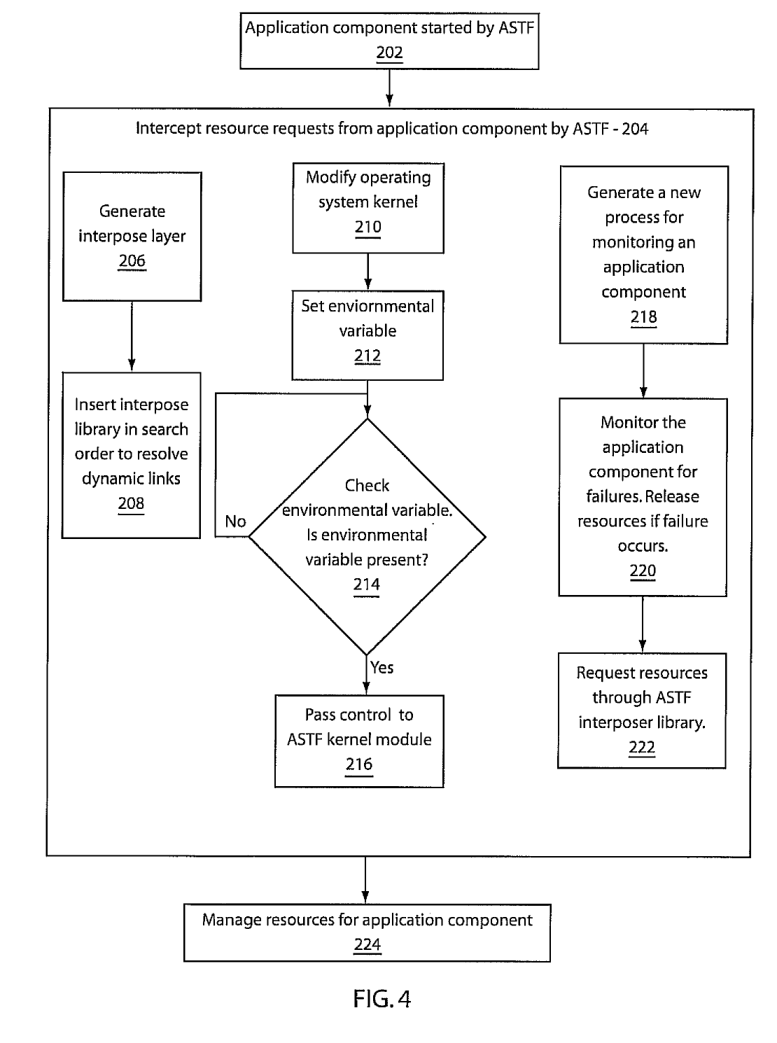

Referring to FIG. 4, a system/method for application session tracking is illustratively depicted. In block 202, an application component is activated or started for execution using an application session tracking facility (ASTF). In block 204, resource requests by the ASTF are intercepted from the application component.

In block 206, intercepting resource requests includes employing an interpose layer to intercept resource requests and resource assignments to and from the application component. In block 208, an interpose library is inserted in the search order before starting the application component to cause an interpose library to capture and resolve an application component dynamic linked system or service allocation requests for resources, such as shared memory segments, scratch disk space, resources on a webserver, entries the application might have created in LDAP directory services including local or remote resources. Note that this is an exemplary list, not an exhaustive one.

In block 210, intercepting resource requests includes modifying an operating system kernel to permit the ASTF to track, limit and release the system resources. In block 212, an environment variable is set to notify an operating system (OS) that a starting application is to be tracked by an ASTF kernel module in the ASTF. In block 214, the environment variable is checked, and if the environment variable is present, control is passed to the ASTF kernel module to track the application component in block 216. If the environment variable is not present, control continues in the Operating System kernel to supply the requested resources to the application component without the benefit of any additional resource tracking.

In block 218, intercepting resource requests includes generating a new process for monitoring the application component using a library interposer. In block 220, monitoring of the application component for an abnormal failure is performed, and all tracked system resources are released if the abnormal failure occurs. In block 222, resources are requested by the application component from an ASTF library (e.g., interpose library), and the ASTF library requests the resources from the system on behalf of the application.

In block 224, resources are managed by allocating or releasing resources in accordance with resource usage of the application component.

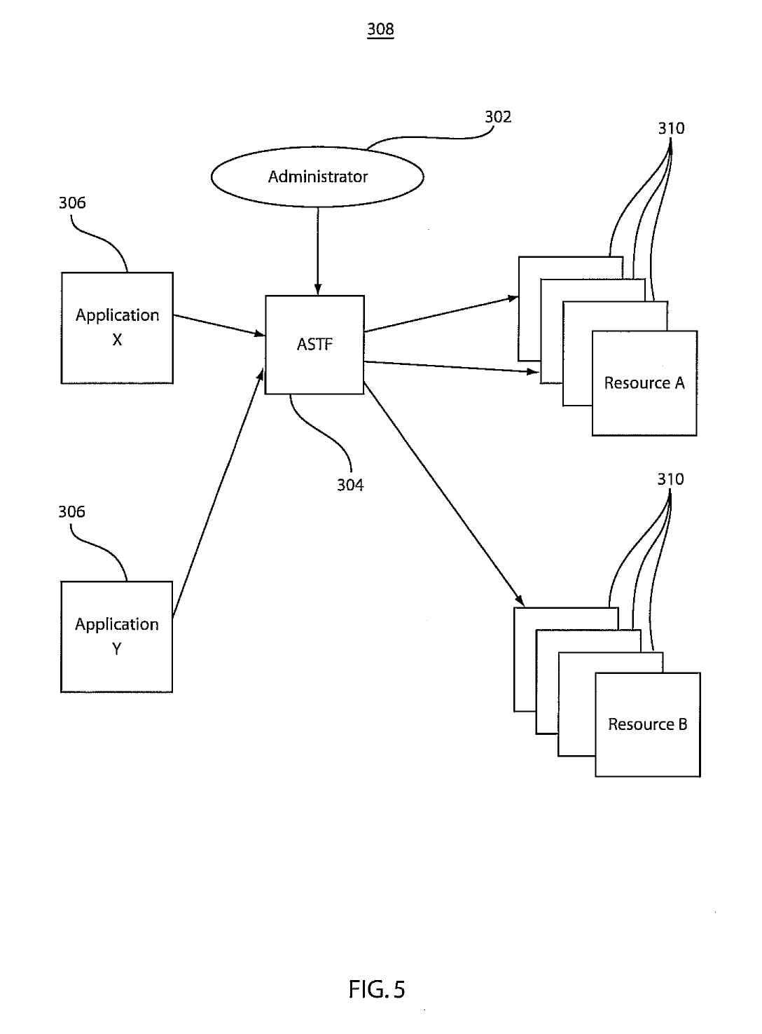

The present invention also includes a mechanism for system or application administrators to declare on a per application basis which resources are to be monitored and controlled as well as the specific resource utilization limits. These limits and the specific quotas are used to enforce resource utilization limits as well as termination cleanup tasks upon a session termination as illustratively depicted in FIG. 5.

Referring to FIG. 5, an Administrator 302 configures an ASTF 304 with resource limits for one or more Applications or Application components 306. Applications or Application components 306 request resources 310 passively or actively from ASTF 304. The ASTF 304 satisfies or limits Applications' or Application components' 306 use of resources based on the Administrator's configuration across one or more computer systems in a network 308.

Having described preferred embodiments of a system and method for application session tracking (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for application session tracking comprising;
activating an application component for execution using an application session tracking facility (ASTF);
intercepting resource requests by the ASTF from the application component; and
managing resources by allocating or releasing resources in accordance with resource usage of the application component.

2. The method as recited in claim 1, wherein intercepting resource requests by the ASTF from the application component includes generating an interpose layer to intercept resource requests and resource assignments to and from the application component.

3. The method as recited in claim 2, further comprising inserting an interpose library in a search order before starting the application component to cause an interpose library to resolve application component dynamic links for system resources.

4. The method as recited in claim 1, wherein intercepting resource requests by the ASTF from the application component includes modifying an operating system kernel to permit the ASTF to track, limit and release the system resources.

5. The method as recited in claim 4, further comprising setting an environment variable to notify an operating system (OS) that a starting application is to be tracked by an ASTF kernel module in the ASTF.

6. The method as recited in claim 4, further comprising checking for the environment variable, and if the environment variable is present passing control to the ASTF kernel module to track the application component.

7. The method as recited in claim 1, wherein intercepting resource requests by the ASTF from the application component includes generating a new process for monitoring the application component.

8. The method as recited in claim 7, wherein monitoring includes monitoring the application component for an abnormal failure and releasing all tracked system resources if an abnormal failure occurs.

9. The method as recited in claim 7, further comprising:
requesting resources by the application component from an ASTF library; and
requesting the resources by the ASTF library.

10. A computer readable medium comprising a computer readable program for application session tracking, wherein the computer readable program when executed on a computer causes the computer to perform the steps of:
activating an application component for execution using an application session tracking facility (ASTF);
intercepting resource requests by the ASTF from the application component; and
managing resources by allocating or releasing resources in accordance with resource usage of the application component.

11. The computer readable medium as recited in claim 10, wherein intercepting resource requests by the ASTF from the application component includes employing an interpose layer to intercept resource requests and resource assignments to and from the application component.

12. The computer readable medium as recited in claim 11, further comprising inserting an interpose library in a search order before starting the application component to cause an interpose library to resolve application component dynamic links for system resources.

13. The computer readable medium as recited in claim 10, wherein intercepting resource requests by the ASTF from the application component includes modifying an operating system kernel to permit the ASTF to track, limit and release the system resources.

14. The computer readable medium as recited in claim 13, further comprising setting an environment variable to notify an operating system (OS) that a starting application is to be tracked by an ASTF kernel module in the ASTF.

15. The computer readable medium as recited in claim 13, further comprising checking for the environment variable, and if the environment variable is present passing control to the ASTF kernel module to track the application component.

16. The computer readable medium as recited in claim 10, wherein intercepting resource requests by the ASTF from the application component includes generating a new process for monitoring the application component.

17. The computer readable medium as recited in claim 16, wherein monitoring includes monitoring the application component for an abnormal failure and releasing all tracked system resources if the abnormal failure occurs.

18. The computer readable medium as recited in claim 16, further comprising:
requesting resources by the application component from an ASTF library; and
requesting the resources by the ASTF library.

19. A system for session tracking, comprising:
a computer having an operating system and at least one application component stored and executed on computer media;
an application session tracking facility (ASTF) accessible by the computer; and
an intercepting mechanism generated by the ASTF to track, limit and release system resources associated with the application component.

20. The system as recited in claim 19, wherein the intercepting mechanism includes an interpose layer configured to intercept and act on requests for resources by the application component.

21. The system as recited in claim 19, wherein the intercepting mechanism includes a kernel module of the ASTF which is substituted for an operating system kernel in accordance with an environmental variable, the kernel module configured to intercept and act on requests for resources by the application component.

22. The system as recited in claim 19, wherein the intercepting mechanism includes an interpose library configured to intercept and act on requests for resources by the application component.

23. The system as recited in claim 22, wherein the interpose library generates a new process to manage resources for the application component.

24. The system as recited in claim 19, wherein the ASTF is distributed on a network of computers.
